(19) United States
(12) Patent Application Publication
(10) Pub. No.: US 2026/0289815 A1
(43) Pub. Date: Sep. 24, 2026

(54) DEVIATION AMOUNT DETECTION DEVICE, DRIVER MONITORING SYSTEM, AND DEVIATION AMOUNT DETECTION METHOD

(71) Applicant: MITSUBISHI ELECTRIC MOBILITY CORPORATION, Tokyo (JP)

(72) Inventors: Yudai NAKAMURA, Tokyo (JP); Shogo YONEYAMA, Tokyo (JP); Shota NATSUME, Tokyo (JP); Kento TANAKA, Tokyo (JP)

(73) Assignee: MITSUBISHI ELECTRIC MOBILITY CORPORATION, Tokyo (JP)

(21) Appl. No.: 19/475,867

(22) PCT Filed: Jun. 14, 2023
(86) PCT No.: PCT/JP2023/021993

§ 371 Date: Oct. 16, 2025

(51) Int. Cl. G06T 7/73; G06T 7/13; G06T 7/50; G06V 10/44; G06V 10/75; G06V 20/59

(52) U.S. Cl. CPC G06T 7/74; G06T 7/13; G06T 7/50; G06T 2207/30201; G06T 2207/30268; G06V 10/44; G06V 10/751; G06V 20/59

(57) ABSTRACT

A deviation amount detection device includes: an evaluation image acquiring unit to acquire an evaluation image including a feature portion; a search position setting unit to set a plurality of search positions in a predetermined range from the feature portion position in a case if there is no optical axis deviation of the imaging device; a search pattern calculating unit to calculate a search pattern indicating a shape of the feature portion in a case if the feature portion is arranged at each of the search positions, the search pattern being based on an optical axis deviation amount corresponding to each of the search positions; an image comparison unit to compare the feature portion with each of the plurality of search patterns for each of the search positions; and, a deviation amount detection unit to detect an optical axis deviation amount on the basis of a comparison result.

### TECHNICAL FIELD

The present disclosure relates to a deviation amount detection device, a driver monitoring system, and a deviation amount detection method.

### BACKGROUND ART

A camera that captures an image of an occupant is attached to a vehicle in which a driver monitoring system is mounted. The installation position of the camera may deviate from a correct installation position due to work errors or the like by a camera mounting worker. The correct installation position of the camera is, for example, an installation position indicated by a design value. By the installation position of the camera deviating from the correct installation position, an occupant appearing in an image captured by the camera becomes unclear, and as a result, monitoring accuracy of the driver monitoring system may deteriorate.

There is a deviation amount detection device that detects a deviation amount between an installation position of an in-vehicle camera attached to a vehicle and a correct installation position of the in-vehicle camera (see Patent Literature 1). In the deviation amount detection device, an electronic control unit extracts plane-symmetric feature points from a plane-symmetric object appearing in an image captured by the in-vehicle camera, and calculates a deviation amount from the plane-symmetric feature point.

### CITATION LIST

### Patent Literature

Patent Literature 1: JP 2010-181209 A

### SUMMARY OF INVENTION

### Technical Problem

The calculation of the deviation amount by the deviation amount detection device disclosed in Patent Literature 1 is based on the premise that the electronic control unit extracts plane-symmetric feature points. When the correct installation position of the in-vehicle camera is a position facing the plane-symmetric object and the in-vehicle camera is installed at the position facing the plane-symmetric object, the electronic control unit can extract the plane-symmetric feature point, but when the spacing between the installation position of the in-vehicle camera and the position facing the object is larger than an allowable range, the electronic control unit may not be able to extract the plane-symmetric feature point. Therefore, the deviation amount detection device has a problem that the electronic control unit cannot calculate the deviation amount depending on the installation position of the in-vehicle camera.

The present disclosure has been made to solve the above problems, and an object thereof is to obtain a deviation amount detection device capable of detecting a deviation amount between an installation position of an imaging device and a correct installation position regardless of the installation position of the imaging device.

### Solution to Problem

A deviation amount detection device according to the present disclosure includes: an evaluation image acquiring unit to acquire an image including a feature portion in a vehicle captured by an imaging device as an evaluation image; a search position setting unit to set a plurality of search positions distributed in a predetermined range from a position of the feature portion in a case where it is assumed that there is no optical axis deviation of the imaging device in the evaluation image; a search pattern calculating unit to calculate a search pattern indicating a shape of the feature portion in the evaluation image in a case where it is assumed that the feature portion is arranged at each of the search positions, the search pattern being based on an optical axis deviation amount corresponding to each of the search positions; an image comparison unit to compare the feature portion in the evaluation image with each of the plurality of search patterns for each of the search positions; and a deviation amount detection unit to detect an optical axis deviation amount of the imaging device on the basis of a comparison result by the image comparison unit.

### Advantageous Effects of Invention

According to the present disclosure, it is possible to detect a deviation amount between an installation position of an imaging device and a correct installation position regardless of the installation position of the imaging device.

### BRIEF DESCRIPTION OF DRAWINGS

FIG. 1 is a configuration diagram illustrating a configuration example of a deviation amount detection device 2 and a driver monitoring system 3 according to a first embodiment.

FIG. 2A is an explanatory diagram illustrating a captured image when an installation position of an imaging device 1 is a correct installation position, and FIG. 2B is an explanatory diagram illustrating a captured image when the imaging device 1 is installed at an angle in a vehicle height direction.

FIG. 3A is an explanatory diagram illustrating a captured image when the installation position of the imaging device 1 is the correct installation position, and FIG. 3B is an explanatory diagram illustrating a captured image when the imaging device 1 is installed at an angle in a vehicle width direction.

FIG. 4A is an explanatory diagram illustrating a captured image when the installation position of the imaging device 1 is the correct installation position, and FIG. 4B is an explanatory diagram illustrating a captured image when the imaging device 1 is installed in a state of being rotated in an X-Y plane.

FIG. 5A is an explanatory diagram illustrating a captured image when the installation position of the imaging device 1 is the correct installation position, and FIG. 5B is an explanatory diagram illustrating a captured image when the imaging device 1 is installed in a state of being deviated in a front-rear direction.

FIG. 6 is a flowchart illustrating an operation example of the deviation amount detection device 2 according to the first embodiment.

FIG. 7A is an explanatory diagram illustrating an example of a captured image GP, and FIG. 7B is an explanatory diagram illustrating an example of a captured image GP″ after being deviated by optical axis deviation amounts ΔΦ_{X}, ΔΦ_{Y}, and ΔΦᵣₒₗₗ by a sensing unit 31.

FIG. 8 is an explanatory diagram illustrating an example of an evaluation image (edge image) GE.

FIG. 9 is an explanatory diagram of M imaging pixels P_{E,1} to P_{E,M} indicating contours represented by the evaluation image GE.

FIG. 10A is an explanatory diagram illustrating a relationship between a three-dimensional image GS and a position of a contour R of a feature portion in a case where there is no optical axis deviation amount of the imaging device 1, and FIG. 10B is an explanatory diagram illustrating a relationship between the three-dimensional image GS and the position of the contour R of the feature portion in a case where there is an optical axis deviation amount of the imaging device 1.

FIG. 11 is a diagram illustrating an example of a method of calculating a search pattern by a search pattern calculating unit 13.

FIG. 12A is an explanatory diagram illustrating an image of a pixel searching method in a prior example, FIG. 12B is an explanatory diagram illustrating a case that cannot be handled in the prior example, and FIG. 12C is an explanatory diagram illustrating a state in which accuracy of search is reduced in the prior example.

FIGS. 13A and 13B are diagrams illustrating an example of a search pattern calculated according to a search position in the first embodiment.

FIGS. 14A and 14B are diagrams illustrating a hardware configuration example of the deviation amount detection device 2 according to the first embodiment.

FIG. 15 is a diagram illustrating a configuration example of a deviation amount detection device 2b and a driver monitoring system 3 according to a second embodiment.

FIG. 16 is a flowchart illustrating an operation example of the deviation amount detection device 2b according to the second embodiment.

FIG. 17 is an explanatory diagram illustrating an operation example of the deviation amount detection device 2b according to the second embodiment.

### DESCRIPTION OF EMBODIMENTS

Hereinafter, embodiments will be described in detail with reference to the drawings.

### First Embodiment

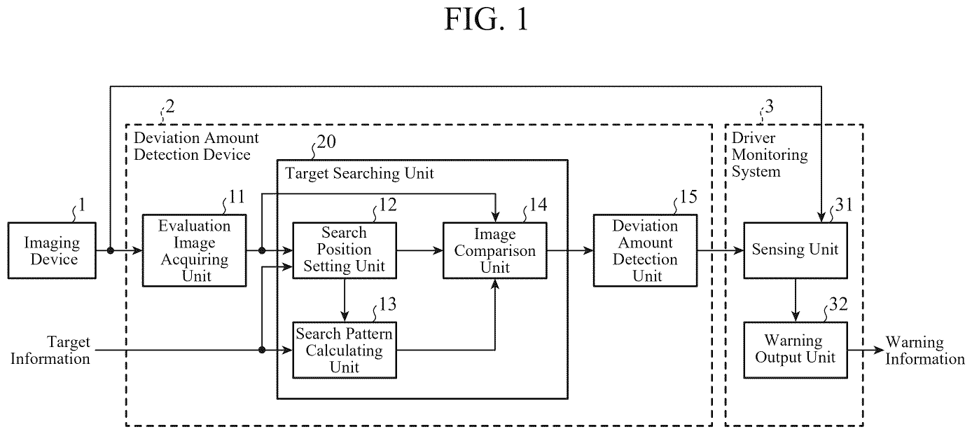

FIG. 1 is a configuration diagram illustrating a configuration example of a deviation amount detection device 2 and a driver monitoring system 3 according to a first embodiment.

In FIG. 1, an imaging device 1 is installed, for example, on a center console, a steering wheel column, an A-pillar, a rearview mirror, a dashboard, an instrument panel, or a ceiling of a vehicle. The imaging device 1 is a camera that captures an image of a feature portion (hereinafter, also referred to as a “feature portion”) of a structure in a vehicle, a driver of the vehicle, or the like. The camera may be, for example, a visible light camera or an infrared camera. The feature portion is, for example, a window frame, an assist grip, a headrest, a B-pillar, a door frame, a shoulder anchor, or a sun visor of the vehicle.

The imaging device 1 outputs a captured image that is an image obtained by capturing a feature portion to the deviation amount detection device 2, and outputs a captured image that is an image obtained by capturing a driver or the like of a vehicle to the driver monitoring system 3. Here, the captured image output from the imaging device 1 to the deviation amount detection device 2 is an image used when the deviation amount detection device 2 detects a deviation amount between an installation position of the imaging device 1 and a correct installation position. Thus, the captured image is, for example, an image captured by the imaging device 1 when the imaging device 1 is attached to the vehicle. Further, the captured image output from the imaging device 1 to the driver monitoring system 3 is an image used when the driver monitoring system 3 detects distracted driving or the like of the driver. Thus, the captured image is, for example, an image captured by the imaging device 1 when the driver is driving the vehicle.

In the first embodiment, since the captured image of the imaging device 1 is used in the driver monitoring system 3, the imaging device 1 needs to be installed in such a manner that, for example, the face of the driver appears when the driver of the vehicle is seated on the driver's seat, and the feature portion appears when the driver is not seated on the driver's seat. In a case where the captured image of the imaging device 1 is not used by the driver monitoring system 3, the imaging device 1 does not need to be installed in such a manner that the face of the driver appears.

<Deviation Amount Detection device 2>

The deviation amount detection device 2 detects a deviation amount between the installation position of the imaging device 1 and the correct installation position of the imaging device 1. The correct installation position of the imaging device 1 is, for example, an installation position indicated by a design value.

Further, the deviation amount detection device 2 calculates, using a positional deviation amount, an optical axis deviation amount that is a deviation amount between an optical axis of the imaging device 1 and an optical axis of the imaging device 1 when an installation angle of the imaging device 1 is a correct installation angle. The correct optical axis of the imaging device 1 is, for example, an optical axis indicated by a design value. The deviation amount detection device 2 outputs the optical axis deviation amount to the driver monitoring system 3.

Note that, here, the term “optical axis deviation” may include not only a concept of deviation between the optical axis of the imaging device 1 and the optical axis of the imaging device 1 when the installation angle of the imaging device 1 is a correct installation angle, but also a concept of deviation between optical axes of a plurality of lenses provided inside the imaging device 1.

For example, as illustrated in FIG. 1, the deviation amount detection device 2 includes an evaluation image acquiring unit 11, a search position setting unit 12, a search pattern calculating unit 13, an image comparison unit 14, and a deviation amount detection unit 15. Among them, the search position setting unit 12, the search pattern calculating unit 13, and the image comparison unit 14 constitute a target searching unit 20.

The evaluation image acquiring unit 11 acquires an image (hereinafter also referred to as a “captured image”) including a feature portion in the vehicle captured by the imaging device 1 as an evaluation image, and outputs the acquired evaluation image to the search position setting unit 12 and the image comparison unit 14.

For example, the evaluation image acquiring unit 11 generates an edge image representing the contour of the feature portion appearing in the captured image, and outputs the generated edge image as an evaluation image to the search position setting unit 12 and the image comparison unit 14. Note that the evaluation image acquiring unit 11 may acquire the edge image from the outside instead of generating the edge image by itself, and output the acquired edge image as the evaluation image to the search position setting unit 12 and the image comparison unit 14.

The search position setting unit 12 sets a plurality of search positions distributed in a predetermined range for the evaluation image on the basis of the evaluation image output from the evaluation image acquiring unit 11, target information input from the outside of the deviation amount detection device 2, and a predetermined assumed range of the optical axis deviation amount of the imaging device 1.

For example, the search position setting unit 12 sets a plurality of search positions distributed in a predetermined range for the evaluation image on the basis of the position of the feature portion in a case where it is assumed that there is no installation deviation of the imaging device 1 in the evaluation image output from the evaluation image acquiring unit 11, the target information, and the predetermined assumed range of the optical axis deviation amount of the imaging device 1.

Here, the target information includes information of a feature portion in a case where it is assumed that there is no installation deviation of the imaging device 1. For example, when a three-dimensional coordinate system based on the position of the imaging device 1 in a case where it is assumed that there is no installation deviation of the imaging device 1 is defined, the target information is constituted by coordinate values of a point group constituting a contour of a feature portion.

Furthermore, the position of the feature portion on the image is represented by, for example, centroid coordinates of the contour of the feature portion. Therefore, the position of the feature portion in a case where it is assumed that there is no installation deviation of the imaging device 1 in the evaluation image is represented as a centroid point of the contour when the point group coordinate values of the feature portion included in the target information is projected on the evaluation image.

The search positions set by the search position setting unit 12 are represented by the centroid coordinates of the contour of the feature portion on the evaluation image. The search position setting unit 12 outputs information indicating the set search positions to the search pattern calculating unit 13 and the image comparison unit 14 as search position information.

The search pattern calculating unit 13 calculates a search pattern indicating the shape of the feature portion in the evaluation image when it is assumed that the feature portion is arranged at each of the plurality of search positions set by the search position setting unit 12.

For example, the search pattern calculating unit 13 calculates a plurality of search patterns (so-called correct answer patterns) corresponding to each of the plurality of search positions on the basis of the target information and the search position information output from the search position setting unit 12.

The search pattern includes, for example, information in which a centroid point (centroid coordinates) of the contour of the feature portion in the evaluation image is associated with a coordinate group of each of the points constituting the contour. Among them, the coordinate group of each of the points constituting the contour is configured by, for example, calculating relative coordinate values from the centroid point of the contour to each of the points constituting the contour at each search position. The search pattern calculating unit 13 outputs information indicating the calculated search pattern to the image comparison unit 14 as search pattern information.

The image comparison unit 14 compares the position and shape of the feature portion for each search position between the evaluation image and the search pattern on the basis of the evaluation image output from the evaluation image acquiring unit 11, the search position information output from the search position setting unit 12, and the search pattern information output from the search pattern calculating unit 13. Then, the image comparison unit 14 outputs the comparison result to the deviation amount detection unit 15. For example, the image comparison unit 14 specifies a search pattern in which the position and shape of the feature portion correspond to the position and shape of the feature portion in the evaluation image among the plurality of search patterns. Then, the image comparison unit 14 outputs information indicating the search position corresponding to the specified search pattern to the deviation amount detection unit 15 as a comparison result.

The deviation amount detection unit 15 detects the optical axis deviation amount of the imaging device 1 on the basis of the comparison result output from the image comparison unit 14. The deviation amount detection unit 15 outputs information indicating the detected amount of the optical axis deviation to the driver monitoring system 3.

### <Driver Monitoring System 3>

As illustrated in FIG. 1, the driver monitoring system 3 includes a sensing unit 31 and a warning output unit 32.

The sensing unit 31 acquires a captured image from the imaging device 1. Further, the sensing unit 31 acquires the optical axis deviation amount from the deviation amount detection unit 15 of the deviation amount detection device 2. Then, the sensing unit 31 monitors the state of the occupant of the vehicle on the basis of the optical axis deviation amount and the captured image. The sensing unit 31 detects, for example, distracted driving of the driver or dozing driving of the driver by monitoring the state of the occupant.

When the sensing unit 31 detects distracted driving, dozing driving, or the like of the driver, the warning output unit 32 outputs warning information indicating a warning to the driver to the electronic control unit (not illustrated) or the like of the vehicle.

In the first embodiment, an example in which the driver monitoring system 3 detects distracted driving, dozing driving, or the like of the driver will be described. However, the driver monitoring system 3 is not limited to one that detects distracted driving or the like of the driver, and may be one that detects a state of an occupant of the vehicle other than the driver, for example. In this case, an occupant of the vehicle is imaged by the imaging device 1.

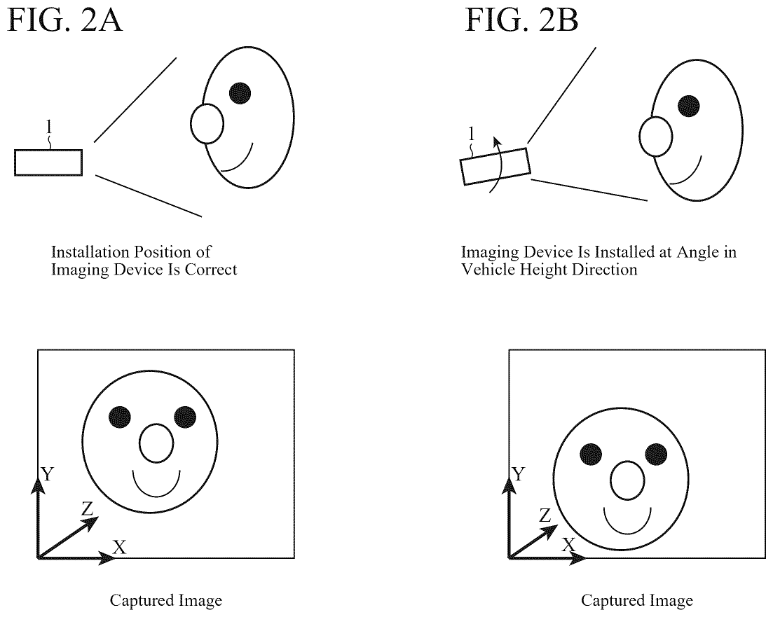

FIG. 2A is an explanatory diagram illustrating a captured image when the installation position of the imaging device 1 is a correct installation position, and FIG. 2B is an explanatory diagram illustrating a captured image when the imaging device 1 is installed at an angle in a vehicle height direction.

In FIGS. 2A and 2B, the X axis is a direction parallel to a vehicle width direction, the Y axis is a direction parallel to the vehicle height direction, and the Z axis is a direction parallel to a front-rear direction of the vehicle.

In each of the captured images in FIGS. 2A and 2B, the face of the driver appears. When the installation position of the imaging device 1 is the correct installation position, the face of the driver appears at the correct position in the captured image. In the example of FIG. 2A, the correct position is approximately at the center of the captured image, and the face of the driver appears approximately at the center of the captured image.

When the imaging device 1 is installed at an angle in the vehicle height direction, the face of the driver appears at a position deviated in the vehicle height direction from the correct position in the captured image as illustrated in FIG. 2B.

If the angle in the vehicle height direction is large, a part of the driver's face does not appear in the captured image, and as a result, it may be difficult for the driver monitoring system 3 to detect distracted driving or the like of the driver.

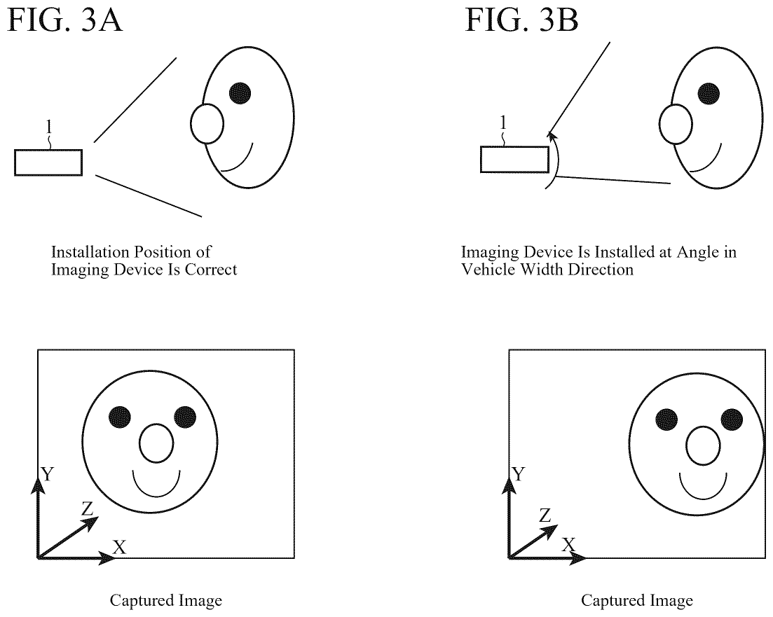

FIG. 3A is an explanatory diagram illustrating a captured image when the installation position of the imaging device 1 is the correct installation position, and FIG. 3B is an explanatory diagram illustrating a captured image when the imaging device 1 is installed at an angle in the vehicle width direction.

In FIGS. 3A and 3B, the X axis, the Y axis, and the Z axis are similar to the X axis, the Y axis, and the Z axis in FIGS. 2A and 2B, respectively.

In each of the captured images in FIGS. 3A and 3B, the face of the driver appears. When the installation position of the imaging device 1 is the correct installation position, the face of the driver appears at the correct position in the captured image. In the example of FIG. 3A, the correct position is approximately at the center of the captured image, and the face of the driver appears approximately at the center of the captured image.

If the imaging device 1 is installed at an angle in the vehicle width direction, the face of the driver appears at a position deviated in the vehicle width direction from the correct position in the captured image as illustrated in FIG. 3B.

If the angle in the vehicle width direction is large, a part of the driver's face does not appear in the captured image, and as a result, it may be difficult for the driver monitoring system 3 to detect distracted driving or the like of the driver.

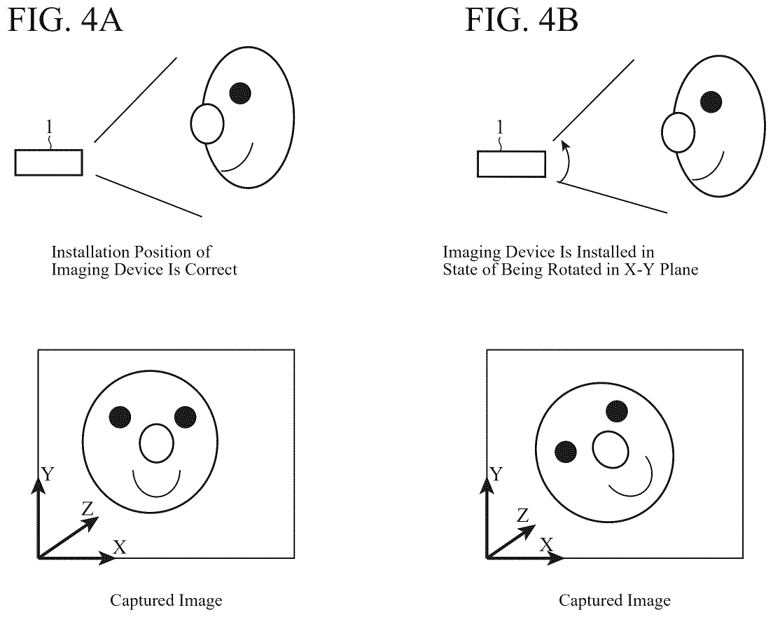

FIG. 4A is an explanatory diagram illustrating a captured image when the installation position of the imaging device 1 is the correct installation position, and FIG. 4B is an explanatory diagram illustrating a captured image when the imaging device 1 is installed in a state of being rotated in an X-Y plane.

In FIGS. 4A and 4B, the X axis, the Y axis, and the Z axis are similar to the X axis, the Y axis, and the Z axis in FIGS. 2A and 2B, respectively.

In each of the captured images in FIGS. 4A and 4B, the face of the driver appears. When the installation position of the imaging device 1 is the correct installation position, the face of the driver appears at the correct position in a state without rotation in the captured image. In the example of FIG. 4A, the correct position is approximately at the center of the captured image, and the face of the driver appears approximately at the center of the captured image in a state without rotation. The state without rotation is a state in which the face of the driver appears in such a manner that a line connecting the left eye and the right eye of the driver is substantially parallel to the X axis.

When the imaging device 1 is installed in a state of rotating in the X-Y plane, the face of the driver appears in a rotated state in the captured image as illustrated in FIG. 4B.

When the rotation angle is large, it is difficult to distinguish the face of the driver, and thus it may be difficult for the driver monitoring system 3 to detect distracted driving or the like of the driver.

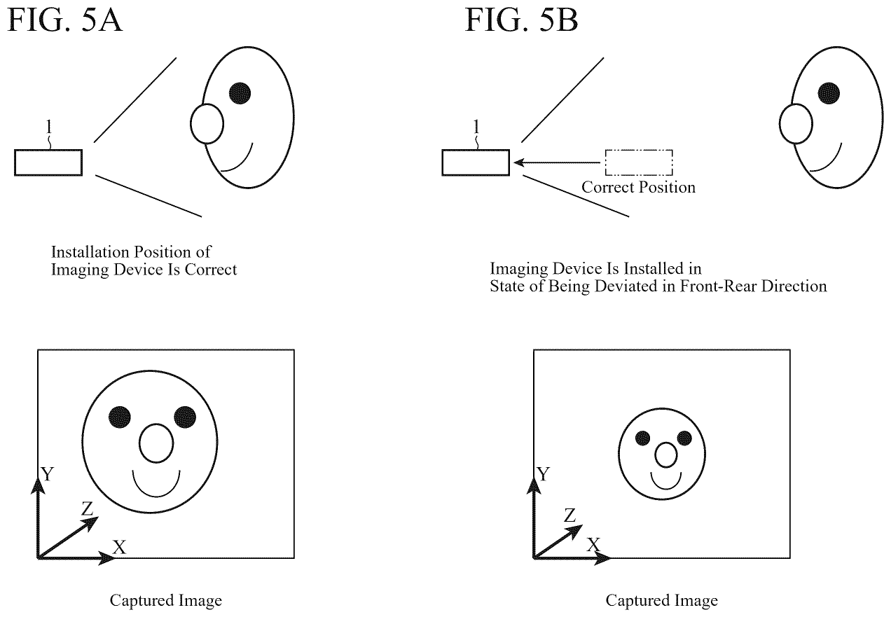

FIG. 5A is an explanatory diagram illustrating a captured image when the installation position of the imaging device 1 is the correct installation position, and FIG. 5B is an explanatory diagram illustrating a captured image when the imaging device 1 is installed in a state of being deviated in the front-rear direction.

In FIGS. 5A and 5B, the X axis, the Y axis, and the Z axis are similar to the X axis, the Y axis, and the Z axis in FIGS. 2A and 2B, respectively.

In each of the captured images in FIGS. 5A and 5B, the face of the driver appears. When the installation position of the imaging device 1 is the correct installation position, the face of the driver appears at the correct position in the captured image. In the example of FIG. 5A, the correct position is approximately at the center of the captured image, and the face of the driver appears approximately at the center of the captured image.

When the imaging device 1 is installed at a position deviated in the front-rear direction, the size of the face of the driver is enlarged or reduced from the original size in the captured image. In the example of FIG. 5B, the imaging device 1 is installed at a position farther from the driver than the correct installation position, and thus the size of the face of the driver is reduced than the original size.

If the enlargement ratio is too large, a part of the driver's face may not appear in the captured image. Further, when a reduction ratio is too large, it becomes difficult to distinguish the face of the driver. Thus, in a case where the imaging device 1 is installed at a position deviated in the front-rear direction, it may be difficult for the driver monitoring system 3 to detect distracted driving or the like of the driver.

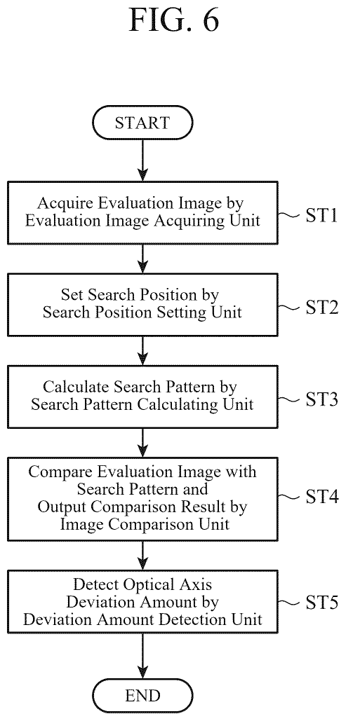

Next, an operation example of the deviation amount detection device 2 and the driver monitoring system 3 illustrated in FIG. 1 will be described. FIG. 6 is a flowchart illustrating an operation example of the deviation amount detection device 2.

Prior to the start of operation of the deviation amount detection device 2, the imaging device 1 captures an image of a feature portion in the vehicle, and outputs a captured image GP, which is an image obtained by capturing the feature portion, to the deviation amount detection device 2.

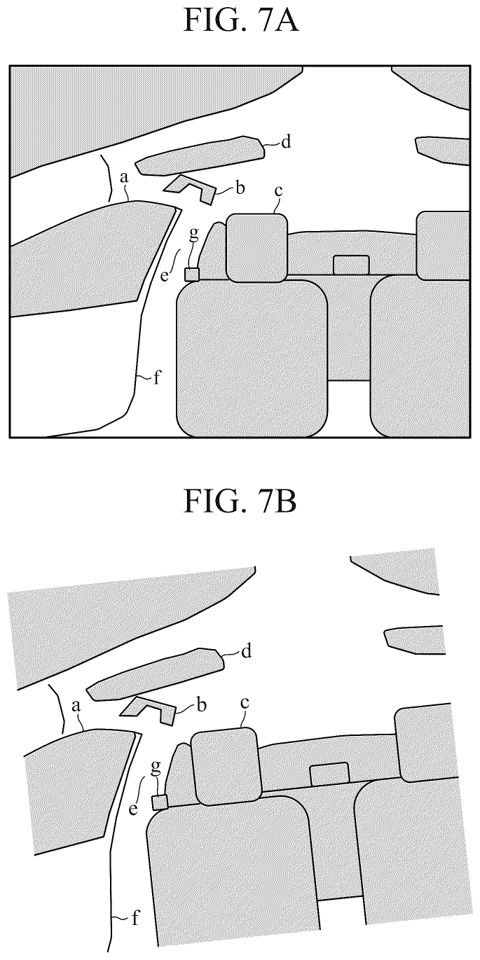

FIG. 7A is an explanatory diagram illustrating an example of the captured image GP. The captured image GP illustrated in FIG. 7A is, for example, a captured image of the imaging device 1 installed on the dashboard, and the captured image GP includes, as feature portions, a window frame a, an assist grip b, a headrest c, a sun visor d, a B-pillar e, a door frame f, a shoulder anchor g, and the like of the vehicle.

The captured image GP output from the imaging device 1 to the deviation amount detection device 2 is basically an image captured when the driver is not seated on the driver's seat. However, even when the driver is seated on the driver's seat, if the driver is seated in such a manner as not to block the structure, the captured image GP may be an image captured when the driver is seated on the driver's seat. The deviation amount detection device 2 starts operation when acquiring the captured image GP from the imaging device 1.

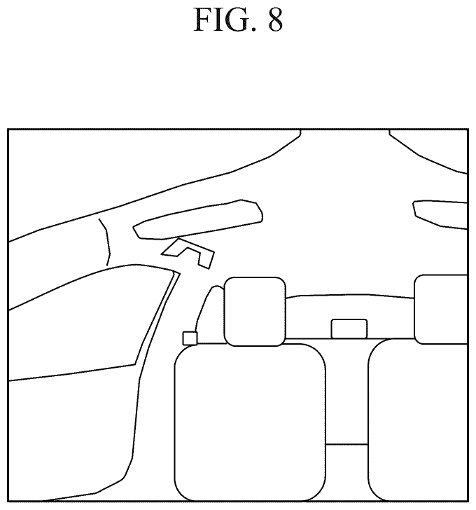

First, the evaluation image acquiring unit 11 acquires the captured image GP including the feature portion in the vehicle captured by the imaging device 1, and generates an edge image representing the contour of the feature portion appearing in the captured image GP. For example, as illustrated in FIG. 8, the outline of the feature portion is a line indicating a boundary between the feature portion and a background or the like expressed in three dimensions. The evaluation image acquiring unit 11 outputs the generated edge image as an evaluation image to the search position setting unit 12 and the image comparison unit 14 (step ST1).

FIG. 8 is an explanatory diagram illustrating an example of an evaluation image (edge image) GE. For example, the evaluation image acquiring unit 11 can obtain the evaluation image (edge image) GE by passing the captured image GP through a Sobel filter or a Prewitt filter.

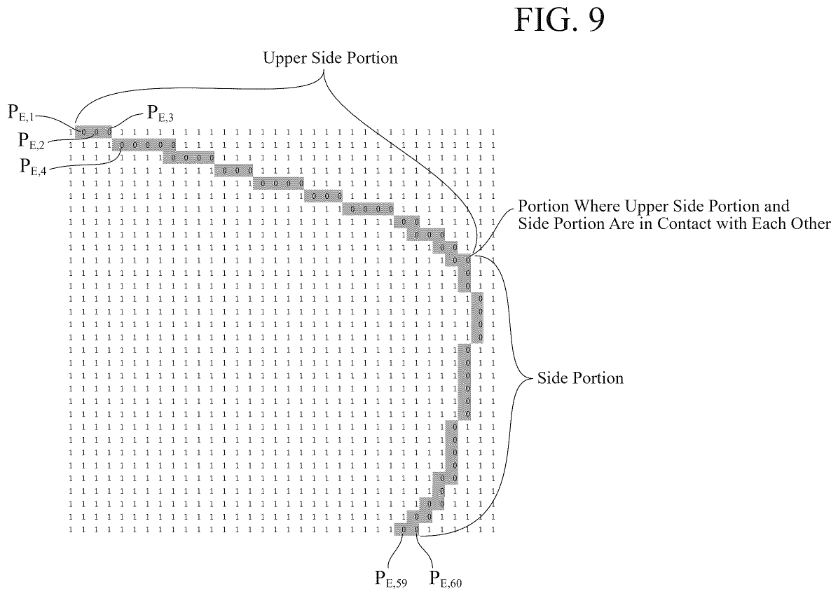

As illustrated in FIG. 9, the contour represented by the evaluation image GE includes M imaging pixels P_{E,1} to P_{E,M}. M is an integer equal to or more than 2, and M=60 in an example of FIG. 9.

FIG. 9 is an explanatory diagram of M imaging pixels P_{E,1} to P_{E,M} indicating contours represented by the evaluation image GE. In FIG. 9, for simplification of description, the evaluation image GE is a two-dimensional image, and the M imaging pixels P_{E,1} to P_{E,M} indicating the contour represented by the two-dimensional evaluation image GE are illustrated. Thus, the horizontal axis in FIG. 9 is the X axis, the vertical axis is the Y axis, and the Z axis is not illustrated. In FIG. 9, pixels having a luminance value of 0 are the imaging pixels P_{E,1} to P_{E,M}, and pixels having a luminance value of 1 are pixels representing other than the contour.

For simplicity of description, the contour illustrated in FIG. 9 represents only a part of a window frame that is one feature portion among a plurality of feature portions appearing in the captured image GP. In the example of FIG. 9, the part of the window frame that is a feature portion includes an upper side portion of the window frame of the vehicle and a side portion of the window frame of the vehicle. The upper side portion of the window frame and the side portion of the window frame are in contact with each other. However, this is merely an example, and the part of the window frame that is a feature portion may include only the upper side portion of the window frame of the vehicle.

Next, the search position setting unit 12 sets a plurality of search positions on the evaluation image GE on the basis of the evaluation image GE output from the evaluation image acquiring unit 11, target information input from the outside of the deviation amount detection device 2, and a predetermined assumed range of the optical axis deviation amount of the imaging device (step ST2).

For example, the search position setting unit 12 sets the search position as follows. First, the search position setting unit 12 sets the centroid position of the feature portion on the evaluation image GE in a case where it is assumed that there is no optical axis deviation of the imaging device 1 as (xc, yc).

Then, the search position setting unit 12 sets four coordinate points determined by (xc−XW1, yc−YW1), (xc−XW1, yc+YW2), (xc+XW2, yc−YW1), and (xc+XW2, yc+YW2) on the evaluation image GE based on the (xc, yc). Then, the search position setting unit 12 sets, as the search positions, a plurality of coordinate points arranged at intervals XI in the x direction (image lateral direction) and intervals YI in the y direction (image longitudinal direction) with respect to a rectangular region surrounded by these four coordinate points.

Note that the intervals XI and YI are set to any values (for example, XI=1 and YI=1) by, for example, the administrator of the deviation amount detection device 2. Furthermore, XW1, XW2, YW1, and YW2 for determining the four coordinate points are set on the basis of an assumed range of the optical axis deviation amount of the imaging device 1. Note that, in order to simplify the description, the description has been given assuming that the region where the search position setting unit 12 sets the search position is a rectangular region, but this region is not limited to the rectangular region. For example, depending on an assumed range of the optical axis deviation amount of the imaging device 1, a trapezoidal region or the like may be used.

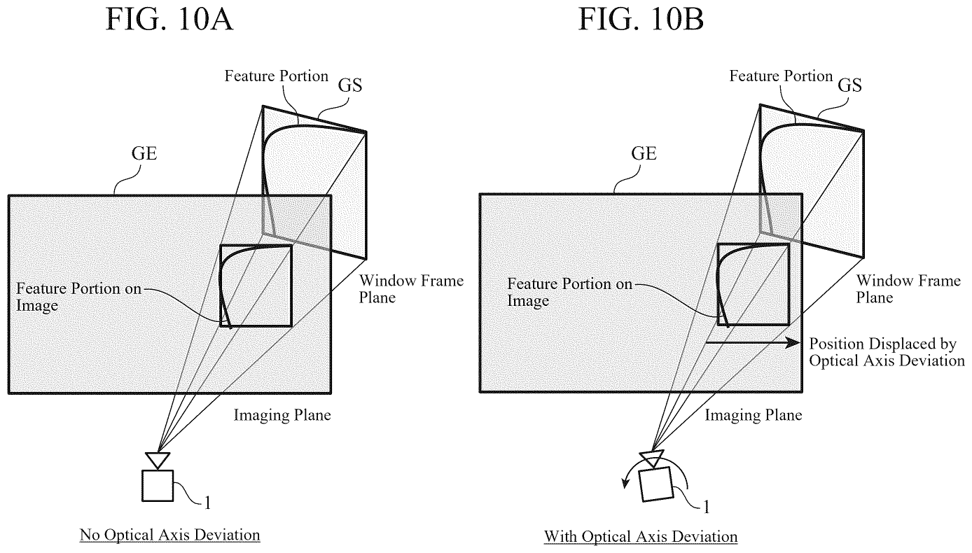

For example, as illustrated in FIG. 10, the position (centroid position) of the contour of the feature portion on the evaluation image GE corresponds to the optical axis deviation amount of the imaging device 1. As illustrated in FIG. 10, when an image (hereinafter, it is also simply referred to as a “three-dimensional image”) GS determined by the information indicating the three-dimensional coordinates of the feature portion imaged by the imaging device 1 is projected on the evaluation image GE, the position (centroid position) of the contour of the feature portion on the evaluation image GE is determined. Note that, although the image GS is expressed as a three-dimensional image in order to simplify the description here, there may be cases where all the three-dimensional coordinates defining the image GS are not positioned on the evaluation image GE. However, even in this case, the search position setting unit 12 can operate similarly to the case where all the three-dimensional coordinates are located on the evaluation image GE.

FIG. 10A illustrates a relationship between a three-dimensional image GS and a position of a contour of a feature portion in a case where there is no optical axis deviation amount of the imaging device 1. At this time, the information indicating the three-dimensional coordinates of the feature portion defining the three-dimensional image GS is included in the target information described above. Furthermore, FIG. 10B illustrates the relationship between the three-dimensional image GS and the position of the contour of the feature portion in a case where there is an optical axis deviation amount of the imaging device 1.

Here, as illustrated in FIG. 10B, in a case where there is an optical axis deviation amount of the imaging device 1, the three-dimensional coordinates of the feature portion imaged by the imaging device 1 also deviate in accordance with the deviation amount, and thus the position (centroid position) of the contour of the feature portion obtained by projecting the three-dimensional image GS on the evaluation image GE also deviates. At this time, it is possible to roughly predict how much the position (centroid position) of the contour of the feature portion deviates depending on how large the optical axis deviation amount of the imaging device 1 is.

For example, in a case where the optical axis deviation of the imaging device 1 corresponding to the lateral direction (x direction) on the evaluation image GE is the largest, it is assumed that the centroid position of the contour R of the feature portion on the evaluation image GE is (xc−XW3, yc) and (xc+XW4, yc) with respect to (xc, yc). In this case, the search position setting unit 12 sets XW1 and XW2 in such a manner that xc−XW3>xc−XW1 and xc+XW4<xc+XW2 hold in such a manner that positions of (xc−XW3, yc) and (xc+XW4, yc) are included in the search positions. Note that a specific optical axis deviation amount in a case where the optical axis deviation of the imaging device 1 is the largest can be acquired in advance from, for example, design information of the imaging device 1.

In addition, the search position setting unit 12 similarly sets YW1 and YW2 in the vertical direction (y direction). In this manner, the search position setting unit 12 defines a rectangular region surrounded by the above-described four coordinate points, and sets a plurality of coordinate points arranged at intervals XI in the x direction (image lateral direction) and at intervals YI in the y direction (image longitudinal direction) as the search positions with respect to the rectangular region.

Note that, when calculating the position of the feature portion on the evaluation image GE corresponding to the optical axis deviation amount of the imaging device 1, the search position setting unit 12 performs calculation as follows, for example. For example, the search position setting unit 12 first calculates a coordinate group T3g′ obtained by multiplying the three-dimensional coordinate group defining the three-dimensional image GS in a case where it is assumed that there is no optical axis deviation illustrated in FIG. 10A, that is, a three-dimensional coordinate group T3g of the contour of the feature portion included in the target information by a rotation matrix corresponding to the optical axis deviation amount.

Next, the search position setting unit 12 projects the three-dimensional image GS defined by the coordinate group T3g′ on the evaluation image GE, thereby obtaining the contour of the feature portion on the evaluation image GE corresponding to the optical axis deviation amount. Then, the search position setting unit 12 calculates the centroid coordinates of the contour of the feature portion on the evaluation image GE, and calculates the obtained coordinate position as the position of the contour of the feature portion on the evaluation image GE. The search position setting unit 12 repeats the above processing while changing the optical axis deviation amount. Thus, the search position setting unit 12 calculates the position of the contour of the feature portion on the evaluation image GE corresponding to the optical axis deviation amount of the imaging device 1.

Note that the position of the contour of the feature portion calculated here (the centroid position of the contour) corresponds to one search position and corresponds to an approximate value of one optical axis deviation amount as follows, for example. Note that in the following description, an approximate value of the optical axis deviation amount is represented by U for easy understanding of the description.

| Search | Centroid position | Optical axis deviation amount |
|---|---|---|
| position | of contour | (approximate value) |
| (x1, y1) | (x1′, y1′) | U1 |
| (x2, y1) | (x2′, y1′) | U2 |
| (x3, y1) | (x3′, y1′) | U3 |
| (x4, y1) | (x4′, y1′) | U4 |
| (x1, y2) | (x1′, y2′) | U5 |
| (x2, y2) | (x2′, y2′) | U6 |
| (x3, y2) | (x3′, y2′) | U7 |
| (x4, y2) | (x4′, y2′) | U8, . . . , etc. |

The search position setting unit 12 outputs information indicating the search position set as described above to the search pattern calculating unit 13 and the image comparison unit 14 as search position information.

Next, the search pattern calculating unit 13 calculates a search pattern indicating the shape of the feature portion in the evaluation image GE in a case where it is assumed that the feature portion is arranged at each of the plurality of search positions (step ST3). For example, the search pattern calculating unit 13 calculates a plurality of search patterns on the basis of the target information and the search position information output from the search position setting unit 12. Then, the search pattern calculating unit 13 outputs information indicating the calculated search pattern to the image comparison unit 14 as search pattern information.

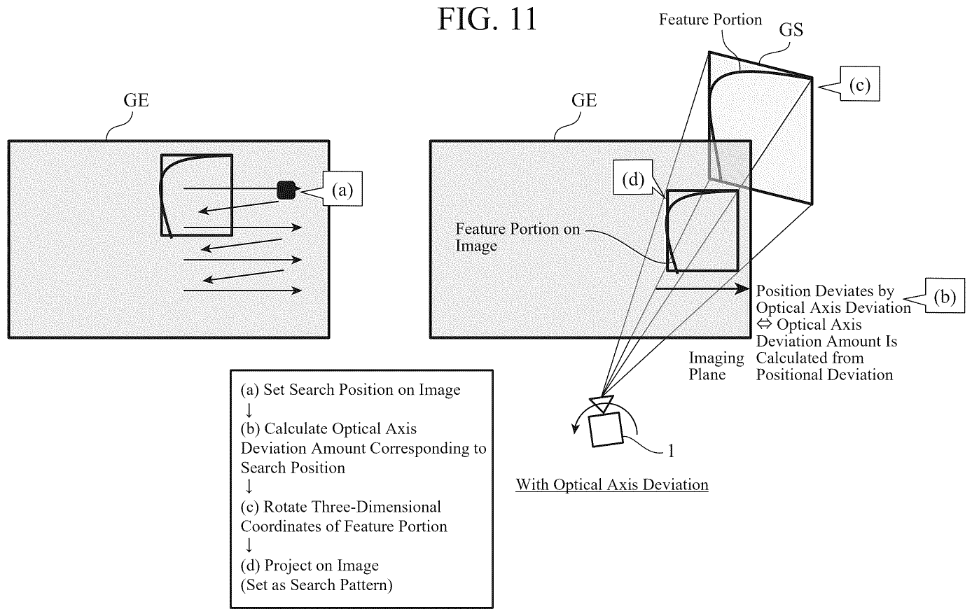

Here, an example of a method of calculating the search pattern by the search pattern calculating unit 13 is illustrated in FIG. 11. The search pattern calculating unit 13 calculates a search pattern along, for example, (a) to (d) illustrated in FIG. 11.

First, the search pattern calculating unit 13 specifies one search position on the evaluation image GE indicated by the search position information (a). Next, the search pattern calculating unit 13 calculates an optical axis deviation amount corresponding to the specified search position (b).

For example, the search pattern calculating unit 13 calculates a difference between the centroid position of the contour of the feature portion in a case where it is assumed that there is no optical axis deviation of the imaging device 1 included in the target information and the centroid position of the contour of the feature portion corresponding to the coordinate value of the specified search position as the positional deviation amount. Then, the search pattern calculating unit 13 calculates the optical axis deviation amount corresponding to the specified search position on the basis of the calculated positional deviation amount.

For example, the search pattern calculating unit 13 calculates positional deviation amounts dxₙ₋ₘ, dyₙ₋ₘ, and dzₙ₋ₘ from the centroid position (xm, ym, zm) of the contour of the feature portion in a case where it is assumed that there is no optical axis deviation of the imaging device 1 and the centroid position (xn, yn, zn) of the contour of the feature portion corresponding to the coordinate value of the specified search position as expressed in the following Expressions (1) to (3).

$${dx}_{n - m} = xn - xm \qquad ( 1 )$$

$${dy}_{n - m} = yn - ym \qquad ( 2 )$$

$${dz}_{n - m} = zn - zm \qquad ( 3 )$$

Note that, in the first embodiment, an image including the contour of the feature portion in a case where it is assumed that there is no optical axis deviation of the imaging device 1 and an image including the contour of the feature portion corresponding to the coordinate value of the specified search position are both two-dimensional images, and thus, dzₙ₋ₘ=0. Even if both the images are three-dimensional images, if zm=zn=constant, dzₙ₋ₘ=0.

The search pattern calculating unit 13 calculates the optical axis deviation amount ΔΦ_{X} between an optical axis ψ_{X} in the X-axis direction in the imaging device 1 and an optical axis Φ_{XREF} in the X-axis direction in the imaging device 1 when there is no optical axis deviation in the X-axis direction by using the positional deviation amount dxₙ₋ₘ in the X-axis direction as expressed in the following Expression (4).

$$Δ {Φ}_{X} = {tan}^{- 1} ( \frac{{dx}_{n - m}}{FL} ) \qquad ( 4 )$$

In Expression (4), FL is a focal length of the imaging device 1 and is a known value. The focal length is, for example, a distance between an image sensor (not illustrated) included in the imaging device 1 and a lens (not illustrated) included in the imaging device 1.

Further, the search pattern calculating unit 13 calculates the optical axis deviation amount ΔΦ_{Y} between an optical axis Φ_{Y} in the Y-axis direction in the imaging device 1 and an optical axis Φ_{YREF} in the Y-axis direction in the imaging device 1 when there is no optical axis deviation in the Y-axis direction by using the positional deviation amount dyₙ₋ₘ in the Y-axis direction as expressed in the following Expression (5).

$$Δ {Φ}_{Y} = {tan}^{- 1} ( \frac{{dy}_{n - m}}{\sqrt{{FL}^{2} + {dx}_{n - m}^{2}}} ) \qquad ( 5 )$$

Further, the search pattern calculating unit 13 determines whether or not the contours represented by both the images coincide with each other by rotating either the image including the contour of the feature portion in a case where it is assumed that there is no optical axis deviation of the imaging device 1 or the image including the contour of the feature portion corresponding to the coordinate value of the specified search position in the X-Y plane.

When the contours coincide with each other by rotating either one of the above two images, the search pattern calculating unit 13 specifies the rotation amount of either one of the images when the contours coincide with each other. Then, the search pattern calculating unit 13 sets the specified rotation amount as the optical axis deviation amount ΔΦᵣₒₗₗ in the rotation direction in the X-Y plane. When the contours coincide with each other in a state where neither of the images is rotated in the X-Y plane, the optical axis deviation amount ΔΦᵣₒₗₗ is 0.

In this manner, the search pattern calculating unit 13 calculates the optical axis deviation amounts ΔΦ_{X}, ΔΦ_{Y}, and ΔΦᵣₒₗₗ corresponding to the specified search positions. Note that the optical axis deviation amount calculated here is different from the approximate value U of the optical axis deviation amount used when the search position setting unit 12 sets the search position described above, and indicates an accurate optical axis deviation amount calculated on the basis of the positional deviation amount at the specified search position.

Next, the search pattern calculating unit 13 rotates, on the basis of the calculated optical axis deviation amount, a group of three-dimensional coordinates defining the three-dimensional image GS in a case where it is assumed that there is no optical axis deviation of the imaging device 1, that is, a group of three-dimensional coordinates of the contour of the feature portion included in the target information (c).

For example, the search pattern calculating unit 13 calculates the coordinate group T3g′ by multiplying the three-dimensional coordinate group T3g of the contour of the feature portion included in the target information by a rotation matrix calculated from the optical axis deviation amount corresponding to the specified search position. Then, the search pattern calculating unit 13 projects the three-dimensional image GS defined by the calculated coordinate group T3g′ on the evaluation image GE (d). Thus, the search pattern calculating unit 13 obtains the contour of the feature portion on the evaluation image GE corresponding to the optical axis deviation amount corresponding to the specified search position.

Then, the search pattern calculating unit 13 associates a centroid point (centroid position) of the obtained contour with a coordinate value group of the contour constituted by coordinate values indicating a relative distance from the centroid point of the contour to each point constituting the contour, and calculates this as a search pattern corresponding to the specified search position.

Hereinafter, the search pattern calculating unit 13 calculates a plurality of search patterns corresponding to each search position by repeatedly performing the above processing on a plurality of search positions. For example, when there are 100 search positions, the search pattern calculating unit 13 calculates 100 search patterns.

Note that a concept of the search pattern calculated here will be described below. Note that in the following description, the optical axis deviation amounts ΔΦ_{X}, ΔΦ_{Y}, and ΔΦᵣₒₗₗ are represented by V for easy understanding of the description.

| | Centroid | | Optical axis |
|---|---|---|---|
| Search | position | Coordinate value group of | deviation |
| position | of contour | contour | amount |
| (x1, y1) | (x1′, y1′) | Points a11, a12, a13, a14, . . . | V1 |
| (x2, y1) | (x2′, y1′) | Points a21, a22, a23, a24, . . . | V2 |
| (x3, y1) | (x3′, y1′) | Points a31, a32, a33, a34, . . . | V3 |
| (x4, y1) | (x4′, y1′) | Points a41, a42, a43, a44, . . . | V4 |
| (x1, y2) | (x1′, y2′) | Points b11, b12, b13, b14, . . . | V5 |
| (x2, y2) | (x2′, y2′) | Points b21, b22, b23, b24, . . . | V6 |
| (x3, y2) | (x3′, y2′) | Points b31, b32, b33, b34, . . . | V7 |
| (x4, y2) | (x4′, y2′) | Points b41, b42, b43, b44, . . . | V8 . . . etc. |

Next, the image comparison unit 14 compares the position and shape of the feature portion for each search position between the evaluation image GE and the search pattern on the basis of the evaluation image GE output from the evaluation image acquiring unit 11, the search position information output from the search position setting unit 12, and the search pattern output from the search pattern calculating unit 13 (step ST4). Then, the image comparison unit 14 outputs the comparison result to the deviation amount detection unit 15.

For example, the image comparison unit 14 specifies a search pattern in which the position and shape of the search pattern correspond to the position and shape of the feature portion in the evaluation image GE among the plurality of search patterns PT, and outputs information indicating a search position corresponding to the specified search pattern to the deviation amount detection unit 15 as a comparison result. Here, the “corresponding search pattern” includes not only a search pattern in which the position and shape completely match the position and shape of the feature portion but also a search pattern in which a matching rate of the position and shape with respect to the position and shape of the feature portion is the highest.

Note that the image comparison unit 14 performs the above comparison using a general technique such as pattern matching processing. Although the pattern matching processing itself is a known technique and thus detailed description thereof is omitted, by the pattern matching processing, line shapes of two contours can be compared with each other and whether or not the two contours are the same line shapes can be determined. The same line shapes include similar line shapes. Further, in the pattern matching processing, when the two contours are the same line shapes, it is possible to search for a pixel corresponding to each of the plurality of pixels indicating one contour among the plurality of pixels representing the other contour.

Next, the deviation amount detection unit 15 detects the optical axis deviation amount of the imaging device 1 on the basis of the comparison result output from the image comparison unit 14 (step ST5).

For example, in a case where the comparison result is information indicating a search position where the matching rate of the position and shape of the feature portion is the highest between the evaluation image GE and the search pattern, the deviation amount detection unit 15 detects the optical axis deviation amount (V described above) corresponding to the search position as the optical axis deviation amount of the imaging device 1. The deviation amount detection unit 15 outputs information indicating the detected amount of the optical axis deviation to the driver monitoring system 3.

The sensing unit 31 of the driver monitoring system 3 acquires a captured image GP′ from the imaging device 1. The captured image GP′ is an image captured when the driver is driving the vehicle. Further, the sensing unit 31 acquires the optical axis deviation amounts ΔΦ_{X}, ΔΦ_{Y}, and ΔΦᵣₒₗₗ from the deviation amount detection unit 15.

For example, the sensing unit 31 performs occupant sensing for identifying the position of the head of the driver appearing in the captured image GP′. When performing occupant sensing, the sensing unit 31 considers that there is a possibility that the installation position of the imaging device 1 is deviated from the correct installation position. For this reason, for example, when sensing the position of the head of the driver, the sensing unit 31 senses a position deviated by the optical axis deviation amounts ΔΦχ, ΔΦΥ, and ΔΦᵣₒₗₗ from the position of the head of the driver in the captured image GP′.

Specifically, assuming that coordinates of the position of the driver's head in the captured image GP′ are (x, y, z), coordinates (x′, y′, z′) of the position sensed by the sensing unit 31 are expressed by the following Expression (6).

$$( \begin{matrix}{x}^{′} \\ {y}^{′} \\ {z}^{′}\end{matrix} ) = ( \begin{matrix}cos ( - {Δϕ}_{X} ) & 0 & sin ( - {Δϕ}_{X} ) \\ 0 & 1 & 0 \\ - sin ( - {Δϕ}_{X} ) & 0 & cos ( - {Δϕ}_{X} )\end{matrix} ) ( \begin{matrix}1 & 0 & 0 \\ 0 & cos ( - {Δϕ}_{Y} ) & - sin ( - {Δϕ}_{Y} ) \\ 0 & sin ( - {Δϕ}_{Y} ) & cos ( - {Δϕ}_{Y} )\end{matrix} ) ( \begin{matrix}cos ( - {Δϕ}_{roll} ) & - sin ( - {Δϕ}_{roll} ) & 0 \\ sin ( - {Δϕ}_{roll} ) & cos ( - {Δϕ}_{roll} ) & 0 \\ 0 & 0 & 1\end{matrix} ) ( \begin{matrix}x \\ y \\ z\end{matrix} ) \qquad ( 6 )$$

FIG. 7B is an explanatory diagram illustrating an example of the captured image GP″ after being deviated by the optical axis deviation amounts ΔΦ_{X}, ΔΦ_{Y}, and ΔΦᵣₒₗₗ by the sensing unit 31. FIG. 7B illustrates a captured image GP″ in which the driver does not appear in order to simplify the drawing.

The sensing unit 31 monitors a state of an occupant of the vehicle on the basis of a pixel value of the coordinates (x′, y′, z′) in the captured image GP′. The sensing unit 31 detects, for example, distracted driving of the driver or dozing driving of the driver by monitoring the state of the occupant. The processing itself of detecting distracted driving of the driver or dozing driving of the driver is a known technique, and thus a detailed description thereof will be omitted.

When the sensing unit 31 detects, for example, distracted driving of the driver or dozing driving of the driver, the warning output unit 32 outputs warning information indicating a warning to the driver to the electronic control unit or the like of the vehicle.

Next, effects of the deviation amount detection device 2 according to the first embodiment will be described. As described above, the deviation amount detection device 2 includes the evaluation image acquiring unit 11, the search position setting unit 12, the search pattern calculating unit 13, the image comparison unit 14, and the deviation amount detection unit 15, so that it is possible to detect the deviation amount between the installation position of the imaging device 1 and the correct installation position regardless of the installation position of the imaging device 1.

In addition, with the configuration as described above, even in a case where the shape of the feature portion is changed on the evaluation image GE when the optical axis deviation of the imaging device 1 occurs, the deviation amount detection device 2 can calculate the optical axis deviation amount in consideration of the change. Therefore, the deviation amount detection device 2 can further improve the detection accuracy of the deviation amount.

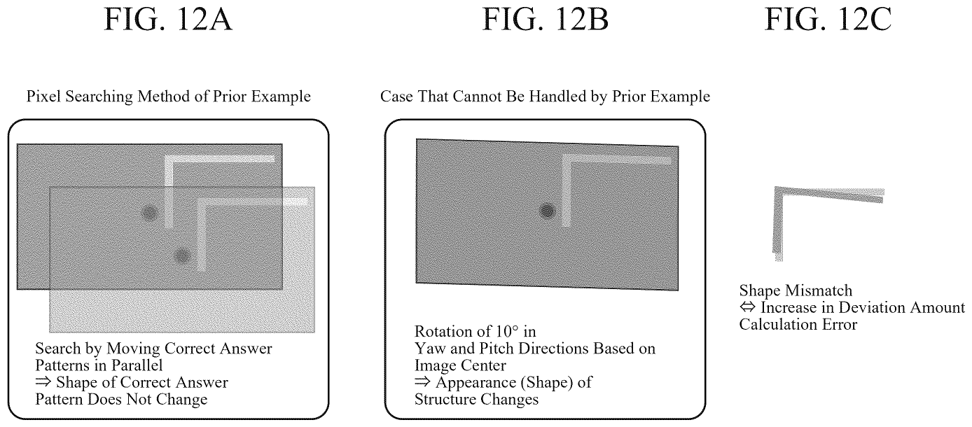

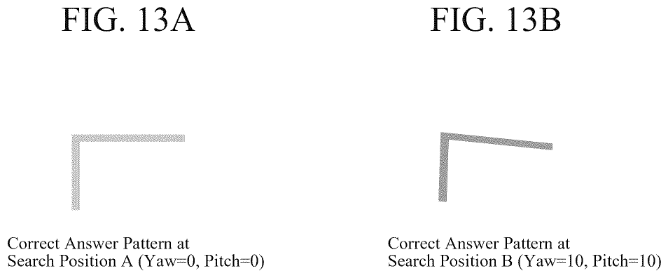

To supplement this point with reference to FIGS. 12 and 13, for example, similarly to the deviation amount detection device 2 according to the first embodiment, as a technology capable of detecting the deviation amount between the installation position of the imaging device 1 and the correct installation position regardless of the installation position of the imaging device 1, for example, a deviation amount detection device according to Japanese Patent No. 7134384 (hereinafter referred to as a “prior example”) is known.

This prior example includes an edge image generating unit, a pixel searching unit, and a deviation amount calculating unit. The edge image generating unit acquires an image of the inside of a vehicle captured by an imaging device, and generates an edge image representing a contour of a structure appearing in the image.

The pixel searching unit acquires a reference image representing a contour of a structure when an installation position of an imaging device is a correct installation position, searches for a reference pixel corresponding to each of imaging pixels, which are a plurality of pixels representing the contour represented by an edge image generated by the edge image generating unit, from among reference pixels, which are a plurality of pixels representing the contour represented by the reference image, and outputs a pixel position of each imaging pixel and a pixel position of a reference pixel corresponding to each imaging pixel.

The deviation amount calculating unit calculates a positional deviation amount, which is a deviation amount between the installation position of the imaging device and the correct installation position, from the pixel position of each imaging pixel output from the pixel searching unit and the pixel position of the reference pixel corresponding to each imaging pixel output from the pixel searching unit. Further, the deviation amount calculating unit calculates, using the positional deviation amount, an optical axis deviation amount that is a deviation amount between the optical axis of the imaging device and the optical axis of the imaging device when the installation angle of the imaging device is the correct installation angle.

An image of the pixel searching method in this prior example is illustrated in FIG. 12A. In the prior example, as illustrated in FIG. 12A, a search is performed by translating a so-called correct answer pattern (reference image) with respect to an edge image (evaluation image). In this case, a shape of a structure appearing in the reference image does not change and is always the same. In other words, in the prior example, the shape of a contour of a feature portion on the evaluation image in a case where it is assumed that there is no optical axis deviation of the imaging device 1 at all the search positions is used as the search pattern (correct answer pattern). Specifically, the relative coordinate values (=representing the shape of the contour) in the search pattern use the same value for all the search positions, and only the centroid position uses different values depending on the search position.

Here, in a case where the optical axis deviation of the imaging device 1 occurs, not only the positional deviation of the structure (feature portion) but also a change in the shape of the structure (feature portion), more specifically, a change in the shape of the contour of the feature portion occurs on the evaluation image. For example, in a case where the optical axis of the imaging device 1 is rotated by 10 degrees in each of a yaw direction and a pitch direction with the center of the evaluation image as a reference, not only the positional deviation of the feature portion but also a change occurs in the shape (appearance) of the contour of the feature portion on the evaluation image, for example, as illustrated in FIG. 12B.

However, in the prior example, the positional deviation of the feature portion is considered in the pixel search, but the change in the shape (appearance) of the contour of the feature portion is not considered. Therefore, in the prior example, as illustrated in FIG. 12C, in a case where there is a change in the shape (appearance) of the feature portion, the shape of the feature portion and the shape of the search pattern do not match, and as a result, there is a possibility that an error in calculation of the optical axis deviation amount increases or the accuracy of calculation of the optical axis deviation amount decreases.

On the other hand, as illustrated in FIG. 13, the deviation amount detection device 2 according to the first embodiment calculates a search pattern (correct answer pattern) according to the search position (optical axis deviation amount) and performs a search (image comparison) using the search pattern. For example, FIG. 13A illustrates an example of a search pattern corresponding to a certain search position A, and FIG. 13B illustrates an example of a search pattern corresponding to another search position B. At this time, the search position A corresponds to the position of the feature portion in a case where the optical axis is not deviated in both the yaw direction and the pitch direction, and the search position B corresponds to the position of the feature portion in a case where the optical axis is rotated by 10 degrees in each of the yaw direction and the pitch direction. Thus, the deviation amount detection device 2 according to the first embodiment can perform a search in consideration of not only the positional deviation of the feature portion but also a change in the shape (appearance) of the contour of the feature portion, and can improve calculation accuracy of the optical axis deviation amount as compared with the prior example.

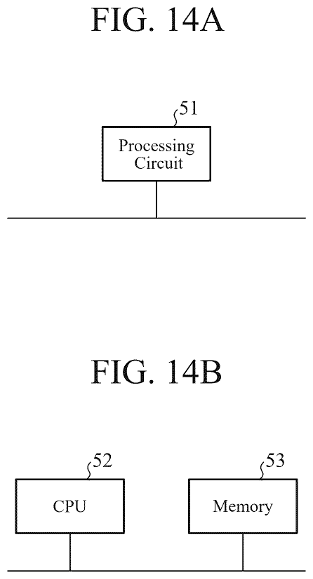

Next, a hardware configuration example of the deviation amount detection device 2 according to the first embodiment will be described with reference to FIG. 14. The functions of the evaluation image acquiring unit 11, the search position setting unit 12, the search pattern calculating unit 13, the image comparison unit 14, and the deviation amount detection unit 15 in the deviation amount detection device 2 are implemented by a processing circuit. The processing circuit may be dedicated hardware as illustrated in FIG. 14A, or may be a central processing unit (CPU, which may also be referred to as a central processing device, a processing device, an arithmetic device, a microprocessor, a microcomputer, a processor, or a digital signal processor (DSP)) 52 that executes a program stored in a memory 53 as illustrated in FIG. 14B.

In a case where the processing circuit is dedicated hardware, a processing circuit 51 corresponds to, for example, a single circuit, a composite circuit, a programmed processor, a parallel programmed processor, an application specific integrated circuit (ASIC), a field programmable gate array (FPGA), or a combination thereof. The functions of the evaluation image acquiring unit 11, the search position setting unit 12, the search pattern calculating unit 13, the image comparison unit 14, and the deviation amount detection unit 15 may be implemented by the processing circuit 51, or the functions of each of the units may be collectively implemented by the processing circuit 51.

When the processing circuit is the CPU 52, the functions of the evaluation image acquiring unit 11, the search position setting unit 12, the search pattern calculating unit 13, the image comparison unit 14, and the deviation amount detection unit 15 are implemented by software, firmware, or a combination of software and firmware. The software and the firmware are described as programs and stored in the memory 53. The processing circuit implements the functions of each of the units by reading and executing the programs stored in the memory 53. That is, the deviation amount detection device 2 includes a memory for storing a program that results in execution of each step illustrated in FIG. 6, for example, when executed by the processing circuit. It can also be said that these programs cause a computer to execute the procedures and methods of the evaluation image acquiring unit 11, the search position setting unit 12, the search pattern calculating unit 13, the image comparison unit 14, and the deviation amount detection unit 15. Here, the memory 53 corresponds to a nonvolatile or volatile semiconductor memory such as a random access memory (RAM), a read only memory (ROM), a flash memory, an erasable programmable ROM (EPROM), or an electrically-EPROM (EEPROM), a magnetic disk, a flexible disk, an optical disk, a compact disk, a mini disk, or a digital versatile disc (DVD).

Note that the functions of the evaluation image acquiring unit 11, the search position setting unit 12, the search pattern calculating unit 13, the image comparison unit 14, and the deviation amount detection unit 15 may be partially implemented by dedicated hardware, and may be partially implemented by software or firmware. For example, the functions of the evaluation image acquiring unit 11 can be implemented by a processing circuit as dedicated hardware, and the functions of the search position setting unit 12, the search pattern calculating unit 13, the image comparison unit 14, and the deviation amount detection unit 15 can be implemented by the processing circuit reading and executing a program stored in the memory 53.

As described above, the processing circuit can implement the functions by hardware, software, firmware, or a combination thereof.

As described above, according to the first embodiment, the deviation amount detection device 2 includes: the evaluation image acquiring unit 11 to acquire an image including a feature portion in a vehicle captured by the imaging device 1 as the evaluation image GE; the search position setting unit 12 to set a plurality of search positions distributed in a predetermined range from a position of the feature portion in a case where it is assumed that there is no optical axis deviation of the imaging device 1 in the evaluation image GE; the search pattern calculating unit 13 to calculate a search pattern indicating a shape of the feature portion in the evaluation image GE in a case where it is assumed that the feature portion is arranged at each of the search positions, the search pattern being based on an optical axis deviation amount corresponding to each of the search positions; the image comparison unit 14 to compare the feature portion in the evaluation image GE with each of the plurality of search patterns for each of the search positions; and the deviation amount detection unit 15 to detect an optical axis deviation amount of the imaging device 1 on the basis of a comparison result by the image comparison unit 14. Thus, the deviation amount detection device 2 according to the first embodiment can detect the deviation amount between the installation position of the imaging device 1 and the correct installation position regardless of the installation position of the imaging device 1. In addition, even in a case where the shape of the feature portion is changed on the evaluation image GE when the optical axis deviation of the imaging device 1 occurs, the deviation amount detection device 2 according to the first embodiment can calculate the optical axis deviation amount in consideration of the change, and can improve the detection accuracy of the deviation amount.

Further, the image comparison unit 14 specifies a search pattern in which a position and a shape of a search pattern correspond to a position and a shape of the feature portion in the evaluation image GE among the plurality of search patterns and sets information indicating a search position corresponding to the specified search pattern as a comparison result, and the deviation amount detection unit 15 detects an optical axis deviation amount corresponding to the search position indicated by the comparison result as the optical axis deviation amount of the imaging device 1. Thus, the deviation amount detection device 2 according to the first embodiment can accurately detect the deviation amount of the imaging device 1.

Further, the search pattern calculating unit 13 calculates the search pattern on the basis of information indicating a three-dimensional position of the feature portion based on a position of the imaging device 1 in a case where it is assumed that there is no optical axis deviation of the imaging device 1 and the optical axis deviation amount corresponding to each of the search positions. Thus, the deviation amount detection device 2 according to the first embodiment can accurately calculate a search pattern corresponding to each search position.

Further, the search pattern calculating unit 13 calculates the search pattern by multiplying a coordinate value indicating a three-dimensional position of the feature portion based on the position of the imaging device 1 in a case where it is assumed that there is no optical axis deviation of the imaging device 1 by a rotation matrix obtained on the basis of the optical axis deviation amount corresponding to each of the search positions and projecting a coordinate value obtained by the multiplication on the evaluation image GE. Thus, the deviation amount detection device 2 according to the first embodiment can accurately calculate a search pattern corresponding to each search position.

Further, the search pattern calculating unit 13 acquires a contour of a feature portion on the evaluation image GE corresponding to the optical axis deviation amount corresponding to each of the search positions by projecting the coordinate value obtained by the multiplication on the evaluation image GE, and sets, as the search pattern, information in which a coordinate value indicating a centroid position of the acquired contour is associated with a coordinate value group indicating a relative distance from the centroid position of the contour to each of points constituting the contour. Thus, the deviation amount detection device 2 according to the first embodiment can define the search pattern corresponding to each search position by the coordinate value group.

Further, the search pattern calculating unit 13 calculates, as a positional deviation amount, a difference between a centroid position of a contour of the feature portion in a case where it is assumed that there is no optical axis deviation of the imaging device 1 in the evaluation image GE and a centroid position of a contour of the feature portion in the evaluation image GE in a case where it is assumed that the feature portion is arranged at each of the search positions, and calculates the optical axis deviation amount corresponding to each of the search positions on the basis of the calculated positional deviation amount. Thus, the deviation amount detection device 2 according to the first embodiment can accurately calculate the optical axis deviation amount corresponding to each search position.

Further, the search position setting unit 12 sets a plurality of search positions in such a manner that the centroid position of the contour of the feature portion on the evaluation image GE when the optical axis deviation amount of the imaging device 1 is the maximum in an assumed range of the optical axis deviation amount of the imaging device 1 is included in at least the search position. Thus, the deviation amount detection device 2 according to the first embodiment can appropriately set a plurality of search positions for the evaluation image GE.

Further, the feature portion is, for example, a window frame, an assist grip, a headrest, a B-pillar, a door frame, a shoulder anchor, or a sun visor of the vehicle.

Thus, the deviation amount detection device 2 according to the first embodiment can easily detect the deviation amount between the installation position of the imaging device 1 and the correct installation position regardless of the installation position of the imaging device 1.

Further, the feature portion is a part of a window frame of the vehicle, and the part of the window frame includes only an upper side portion of the window frame, or an upper side portion of the window frame and a side portion of the window frame in contact with the upper side portion of the window frame. Thus, the deviation amount detection device 2 according to the first embodiment can easily detect the deviation amount between the installation position of the imaging device 1 and the correct installation position regardless of the installation position of the imaging device 1.

Further, the imaging device 1 is installed, for example, on a center console, a steering wheel column, an A-pillar, a rearview mirror, a dashboard, an instrument panel, or a ceiling.

Thus, the deviation amount detection device 2 according to the first embodiment can easily detect the deviation amount between the installation position of the imaging device 1 and the correct installation position regardless of the installation position of the imaging device 1.

Further, according to the first embodiment, the driver monitoring system 3 includes the sensing unit 31 to monitor a state of an occupant of a vehicle using an optical axis deviation amount detected by the deviation amount detection unit 15 of the deviation amount detection device 2 and an image of an inside of the vehicle captured by the imaging device 1. Thus, the driver monitoring system 3 according to the first embodiment can improve the monitoring accuracy of the state of the occupant.

### Second Embodiment

In the first embodiment, the deviation amount detection device capable of detecting the deviation amount between the installation position of the imaging device 1 and the correct installation position regardless of the installation position of the imaging device 1 has been described. In a second embodiment, a deviation amount detection device capable of reducing a calculation amount for detecting a deviation amount as compared with the first embodiment will be described.

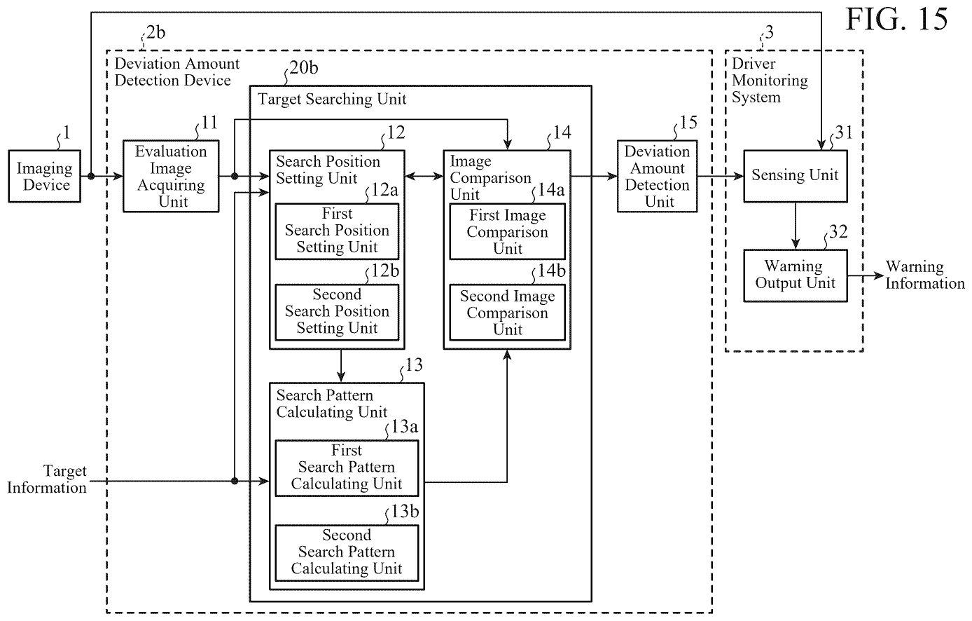

FIG. 15 is a diagram illustrating a configuration example of the deviation amount detection device 2b and the driver monitoring system 3 according to the second embodiment. The deviation amount detection device 2b according to the second embodiment is different from the deviation amount detection device 2 according to the first embodiment illustrated in FIG. 1 in that the target searching unit 20 is changed to a target searching unit 20b. Further, in the target searching unit 20b, the search position setting unit 12, the search pattern calculating unit 13, and the image comparison unit 14 are each divided into two functional units. That is, the deviation amount detection device 2b according to the second embodiment performs the search (image comparison) in two stages. Other configurations of the deviation amount detection device 2b and the driver monitoring system 3 according to the second embodiment are the same as those of the deviation amount detection device 2 and the driver monitoring system 3 according to the first embodiment illustrated in FIG. 1, and thus the same reference numerals are given and the description thereof is omitted.

The search position setting unit 12 includes a first search position setting unit 12a and a second search position setting unit 12b. The search pattern calculating unit 13 includes a first search pattern calculating unit 13a and a second search pattern calculating unit 13b. The image comparison unit 14 includes a first image comparison unit 14a and a second image comparison unit 14b. Among them, a functional unit denoted by reference character a is a functional unit for performing a first search, and a functional unit denoted by reference character b is a functional unit for performing a second search.

### <First Search>

The first search position setting unit 12a sets a plurality of search positions for the first search on the basis of an evaluation image output from the evaluation image acquiring unit 11 and target information input from the outside of the deviation amount detection device 2.

For example, the first search position setting unit 12a sets a plurality of search positions distributed in a predetermined range with respect to the evaluation image on the basis of the position of the feature portion in a case where it is assumed that there is no installation deviation of the imaging device 1 in the evaluation image output from the evaluation image acquiring unit 11 and the target information.

At this time, unlike the search position setting unit 12 in the first embodiment, the first search position setting unit 12a sets the search position without considering the optical axis deviation amount of the imaging device 1. In addition, the first search position setting unit 12a sets the search position in such a manner that a search range in the first search (hereinafter, also referred to as a “first range”) is wider than a search range in a second search (hereinafter, also referred to as a “second range”) described later.

For example, the first search position setting unit 12a sets a predetermined range centered on the position of the feature portion in a case where it is assumed that there is no installation deviation of the imaging device 1 in the evaluation image as a first range, and sets the search position with respect to the first range. Further, at this time, the first search position setting unit 12a makes the interval of the search positions set in the first range narrower than the interval of the search positions set in the second range.

The first search pattern calculating unit 13a calculates a first search pattern on the basis of the target information. At this time, unlike the search pattern calculating unit 13 in the first embodiment, the first search pattern calculating unit 13a calculates the search pattern without considering the optical axis deviation amount of the imaging device 1.

For example, the first search pattern calculating unit 13a associates a centroid point (centroid position) of a contour of the feature portion in a case where it is assumed that there is no installation deviation of the imaging device 1 with a coordinate group of a contour constituted by relative coordinate values from the centroid point of the contour to each point constituting the contour on the basis of the target information, and calculates the coordinate group as the search pattern.

The first image comparison unit 14a compares the position and shape of the feature portion for each search position between the evaluation image and the search pattern on the basis of the evaluation image output from the evaluation image acquiring unit 11, the search position information set by the first search position setting unit 12a, and the search pattern calculated by the first search pattern calculating unit 13a. Then, the first image comparison unit 14a outputs the comparison result to the second search position setting unit 12b.

For example, the first image comparison unit 14a outputs, to the second search position setting unit 12b, information indicating a search position when the position and shape of the feature portion in the evaluation image correspond to the position and shape of the first search pattern among the plurality of search positions distributed in the first range as a comparison result. Note that the search (first search) here is a search considering only the positional deviation of the feature portion, similarly to the above-described prior example, and does not consider a change in the shape (appearance) of the contour of the feature portion accompanying the optical axis deviation of the imaging device 1.

### <Second Search>

The second search position setting unit 12b sets a plurality of search positions for the second search on the basis of the evaluation image output from the evaluation image acquiring unit 11 and the comparison result output from the first image comparison unit 14a.

For example, the second search position setting unit 12b sets a predetermined range from the search position indicated by the comparison result by the first image comparison unit 14a as a second range, and sets a plurality of search positions distributed in the second range. At this time, the second search position setting unit 12b sets the search positions in such a manner that the second range is narrower than the above-described first range and the interval between the search positions is wider than the interval between the search positions in the above-described first range.

The second search pattern calculating unit 13b calculates a plurality of second search patterns based on the target information and the search position information set by the first search position setting unit 12a. For example, the second search pattern calculating unit 13b calculates the shape of the contour of the feature portion in a case where it is assumed that the feature portion in a case where it is assumed that there is no installation deviation of the imaging device 1 is arranged with respect to each search position set by the second search position setting unit 12b.

At this time, as described in the first embodiment, since the second search pattern calculating unit 13b can know the approximate value of the optical axis deviation amount corresponding to each search position set by the second search position setting unit 12b, the second search pattern calculating unit 13b calculates the positional deviation amount of the feature portion for each search position from the approximate value of the optical axis deviation amount. Hereinafter, similarly to the search pattern calculating unit 13 in the first embodiment, the second search pattern calculating unit 13b calculates the optical axis deviation amount for each search position from the calculated positional deviation amount, calculates the shape of the contour of the feature portion in a case where it is assumed to be arranged at each search position from the calculated optical axis deviation amount, and sets the shape as the search pattern for each search position.

The second image comparison unit 14b compares the position and shape of the feature portion for each search position between the evaluation image and the search pattern on the basis of the evaluation image output from the evaluation image acquiring unit 11, the search position information set by the second search position setting unit 12b, and the search pattern calculated by the second search pattern calculating unit 13b. Then, the second image comparison unit 14b outputs the comparison result to the deviation amount detection unit 15.

For example, the second image comparison unit 14b specifies a second search pattern in which the position and shape of the feature portion correspond to the position and shape of the feature portion in the evaluation image among the plurality of second search patterns. Then, the image comparison unit 14 outputs information indicating the search position corresponding to the specified second search pattern to the deviation amount detection unit 15 as a comparison result. Note that the search (second search) here is a search in consideration of not only the positional deviation of the feature portion but also the change in the shape (appearance) of the contour of the feature portion accompanying the optical axis deviation of the imaging device 1, similarly to the first embodiment described above.

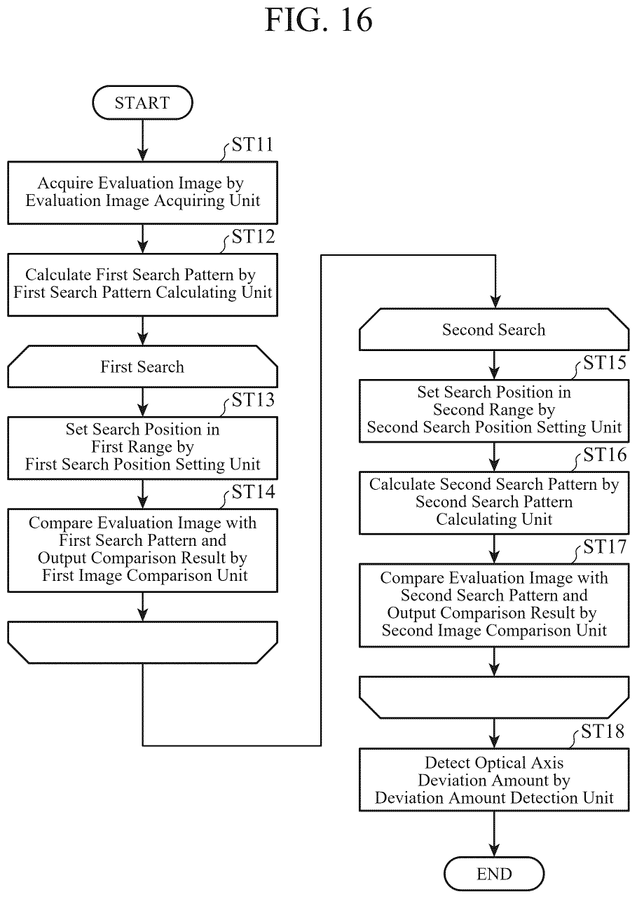

Next, an operation example of the deviation amount detection device 2b according to the second embodiment will be described by referring to a flowchart illustrated in FIG. 16. Unlike the deviation amount detection device 2 according to the first embodiment, the deviation amount detection device 2b according to the second embodiment performs the search in two stages (first search and second search).

First, the evaluation image acquiring unit 11 acquires a captured image GP including a feature portion in the vehicle captured by the imaging device 1, generates an edge image representing a contour of the feature portion appearing in the captured image GP, and outputs the generated edge image as an evaluation image to the first search position setting unit 12a, the second search position setting unit 12b, the first image comparison unit 14a, and the second image comparison unit 14b (step ST11).

Next, the first search pattern calculating unit 13a calculates a first search pattern on the basis of the target information (step ST12). At this time, unlike the search pattern calculating unit 13 in the first embodiment, the first search pattern calculating unit 13a calculates the search pattern without considering the optical axis deviation amount of the imaging device 1.

Next, the first search position setting unit 12a sets a plurality of search positions distributed in a predetermined range for the evaluation image GE on the basis of the position of the feature portion in a case where it is assumed that there is no installation deviation of the imaging device 1 in the evaluation image output from the evaluation image acquiring unit 11 and the target information (step ST13). At this time, unlike the search position setting unit 12 in the first embodiment, the first search position setting unit 12a sets the search position without considering the optical axis deviation amount of the imaging device 1.

Next, the first image comparison unit 14a compares the position and shape of the feature portion for each search position between the evaluation image GE and the first search pattern on the basis of the evaluation image GE output from the evaluation image acquiring unit 11, the search position information set by the first search position setting unit 12a, and the first search pattern calculated by the first search pattern calculating unit 13a (step ST14). Then, the first image comparison unit 14a outputs the comparison result to the second search position setting unit 12b.

Next, the second search position setting unit 12b sets a plurality of search positions for the second search on the basis of the evaluation image GE output from the evaluation image acquiring unit 11 and the comparison result output from the first image comparison unit 14a (step ST15).

For example, the second search position setting unit 12b sets a predetermined range from the search position indicated by the comparison result by the first image comparison unit 14a as a second range, and sets a plurality of search positions distributed in the second range. At this time, the second search position setting unit 12b sets the search positions in such a manner that the second range is narrower than the above-described first range and the interval between the search positions is wider than the interval between the search positions in the above-described first range.

Next, the second search pattern calculating unit 13b calculates a plurality of second search patterns based on the target information and the search position information set by the first search position setting unit 12a (step ST16). At this time, the second search pattern calculating unit 13b calculates a search pattern in consideration of the optical axis deviation amount for each search position as described above.

Next, the second image comparison unit 14b compares the position and shape of the feature portion for each search position between the evaluation image GE and the search pattern on the basis of the evaluation image GE output from the evaluation image acquiring unit 11, the search position information set by the second search position setting unit 12b, and the search pattern calculated by the second search pattern calculating unit 13b (step ST17). Then, the second image comparison unit 14b outputs the comparison result to the deviation amount detection unit 15.

Next, the deviation amount detection unit 15 detects the optical axis deviation amount of the imaging device 1 on the basis of the comparison result output from the second image comparison unit 14b (step ST18).

Next, effects of the deviation amount detection device 2b according to the second embodiment will be described. As described above, the deviation amount detection device 2b includes the first search position setting unit 12a and the second search position setting unit 12b, the first search pattern calculating unit 13a and the second search pattern calculating unit 13b, and the first image comparison unit 14a and the second image comparison unit 14b, so that it is possible to detect the deviation amount between the installation position of the imaging device 1 and the correct installation position regardless of the installation position of the imaging device 1, similarly to the deviation amount detection device 2 according to the first embodiment.

In addition, since the deviation amount detection device 2b has the above configuration, similarly to the deviation amount detection device 2 according to the first embodiment, not only the detection accuracy of the deviation amount can be improved, but also the calculation amount for detecting the deviation amount can be reduced as compared with the deviation amount detection device 2 according to the first embodiment.

For example, in the deviation amount detection device 2 according to the first embodiment, since the search pattern calculating unit 13 calculates the search pattern (relative position coordinates of the contour of the feature portion) for each search position set by the search position setting unit 12, the calculation amount may increase. In this regard, in the deviation amount detection device 2b according to the second embodiment, only the second search pattern calculating unit 13b calculates a search pattern for each search position as described above, and the first search pattern calculating unit 13a calculates a search pattern similar to that of the prior example.

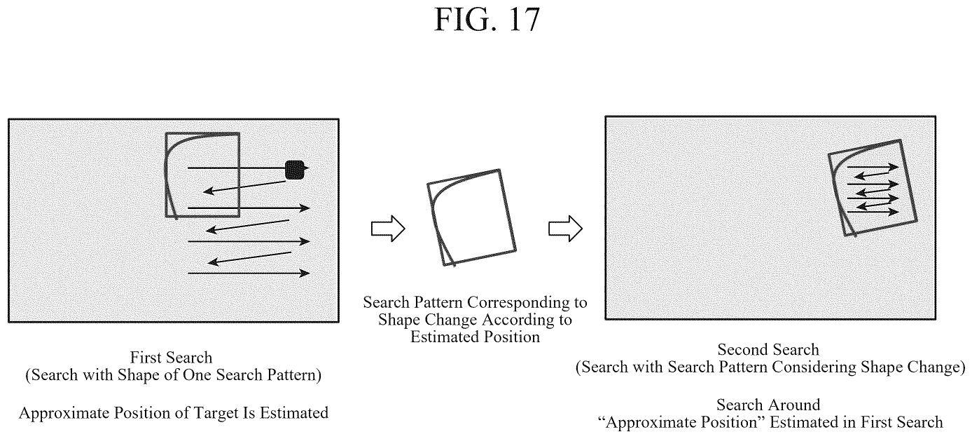

That is, as illustrated in FIG. 17, for example, the deviation amount detection device 2b according to the second embodiment first performs a search (search with one search pattern) similar to the prior example over a slightly wide range in the first search, and narrows down an approximate position and range to be intensively searched in the evaluation image. Then, in the second search, the deviation amount detection device 2b sets a search position for the narrowed range, and calculates a search pattern according to the set search position. Then, the deviation amount detection device 2b performs a search using the calculated search pattern. Thus, the deviation amount detection device 2b can improve the detection accuracy of the deviation amount similarly to the deviation amount detection device 2 according to the first embodiment. Furthermore, since the deviation amount detection device 2b calculates the search pattern for each search position only in a relatively limited range, the amount of calculation for detecting the deviation amount can be reduced as compared with the deviation amount detection device 2 according to the first embodiment.

Note that in the above description, an example has been described in which the second search pattern calculating unit 13b calculates a search pattern for each search position with respect to a plurality of search positions set by the second search position setting unit 12b, and the second image comparison unit 14b compares the position and shape of the feature portion for each search position between the evaluation image and the search pattern. However, the second search pattern calculating unit 13b may calculate a search pattern corresponding to any one search position among the plurality of search positions set by the second search position setting unit 12b, and the second image comparison unit 14b may compare the position and shape of the feature portion for each search position with the evaluation image using this one search pattern.

That is, the range of the second search defined by the setting of the search position by the second search position setting unit 12b is narrower than the range of the first search. Therefore, even if the second search pattern calculating unit 13b calculates a search pattern for each search position, there is a possibility that there is no significant difference between the each of the search patterns. Accordingly, the second search pattern calculating unit 13b may calculate a search pattern corresponding to any one search position among the plurality of search positions set by the second search position setting unit 12b, and the second image comparison unit 14b may perform the second search using this one search pattern. In this case, the deviation amount detection device 2b can further reduce the calculation amount for detecting the deviation amount.

As described above, according to the second embodiment, the deviation amount detection device 2b includes: the evaluation image acquiring unit 11 to acquire an image including a feature portion in a vehicle captured by the imaging device 1 as the evaluation image GE; the first search position setting unit 12a to set a plurality of search positions distributed in a predetermined first range from a position of the feature portion in a case where it is assumed that there is no optical axis deviation of the imaging device 1 in the evaluation image GE; the first search pattern calculating unit 13a to calculate a first search pattern indicating a shape of the feature portion in a case where it is assumed that there is no optical axis deviation of the imaging device 1 in the evaluation image GE; the first image comparison unit 14a to compare the feature portion in the evaluation image GE with the first search pattern for each of the search positions distributed in the first range; the second search position setting unit 12b to set a plurality of search positions distributed in a predetermined second range from a position of the feature portion in a case where it is assumed that there is no optical axis deviation of the imaging device 1 in the evaluation image GE on the basis of a comparison result by the first image comparison unit 14a; the second search pattern calculating unit 13b to calculate a second search pattern indicating a shape of the feature portion in the evaluation image GE in a case where it is assumed that the feature portion is arranged in each of the search positions distributed in the second range, the second search pattern being based on an optical axis deviation amount corresponding to each of the search positions distributed in the second range; the second image comparison unit 14b to compare the feature portion in the evaluation image GE with each of the plurality of second search patterns for each of the search positions distributed in the second range; and the deviation amount detection unit 15 to detect an optical axis deviation amount of the imaging device 1 on the basis of a comparison result by the second image comparison unit 14b. Thus, in addition to the effects of the first embodiment, the deviation amount detection device 2b according to the second embodiment can reduce the calculation amount for detecting the deviation amount as compared with the deviation amount detection device 2 according to the first embodiment.

Furthermore, the first image comparison unit 14a sets, as a comparison result, information indicating a search position when a position and a shape of the feature portion in the evaluation image GE correspond to a position and a shape of the first search pattern among a plurality of search positions distributed in the first range, and the second search position setting unit 12b sets, as the second range, a predetermined range from the search position indicated by the comparison result by the first image comparison unit 14a, and sets a plurality of search positions distributed in the second range. Thus, the deviation amount detection device 2b according to the second embodiment can appropriately set the second range.

In addition, the first range is wider than the second range, and the interval between the plurality of search positions distributed in the first range is narrower than the interval between the plurality of search positions distributed in the second range. Thus, the deviation amount detection device 2b according to the second embodiment can improve the calculation efficiency for detecting the deviation amount.

Furthermore, the second search pattern calculating unit 13b calculates the second search pattern on the basis of information indicating a three-dimensional position of the feature portion based on a position of the imaging device 1 in a case where it is assumed that there is no optical axis deviation of the imaging device 1 and the optical axis deviation amount corresponding to each of the search positions distributed in the second range. Thus, the deviation amount detection device 2b according to the second embodiment can accurately calculate the second search pattern corresponding to each search position distributed in the second range.

Note that, in the present disclosure, free combinations of the individual embodiments, modifications of any components of the individual embodiments, or omissions of any components in the individual embodiments are possible.

### INDUSTRIAL APPLICABILITY

The present disclosure makes it possible to detect the amount of deviation between an installation position of an imaging device and a correct installation position regardless of the installation position of the imaging device, and is suitable for use in a deviation amount detection device, a driver monitoring system, and a deviation amount detection method.

### REFERENCE SIGNS LIST

1: imaging device, 2, 2b: deviation amount detection device, 3: driver monitoring system, 11: evaluation image acquiring unit, 12: search position setting unit, 12a: first search position setting unit, 12b: second search position setting unit, 13: search pattern calculating unit, 13a: first search pattern calculating unit, 13b: second search pattern calculating unit, 14: image comparison unit, 14a: first image comparison unit, 14b: second image comparison unit, 15: deviation amount calculating unit, 20, 20b: target searching unit, 31: sensing unit, 32: warning output unit, 51: processing circuit, 52: CPU, 53: memory

1. A deviation amount detection device comprising:
a processor; and
a memory storing a program, upon executed by the processor, to perform a process:
to acquire an image including a feature portion in a vehicle captured by an imaging device as an evaluation image;
to set a plurality of search positions distributed in a predetermined range from a position of the feature portion in a case where it is assumed that there is no optical axis deviation of the imaging device in the evaluation image;
to calculate a search pattern indicating a shape of the feature portion in the evaluation image in a case where it is assumed that the feature portion is arranged at each of the search positions, the search pattern being based on an optical axis deviation amount corresponding to each of the search positions;
to compare the feature portion in the evaluation image with each of the plurality of search patterns for each of the search positions; and
to detect an optical axis deviation amount of the imaging device on a basis of a comparison result.

2. The deviation amount detection device according to claim 1, wherein
the process
specifies a search pattern in which a position and a shape of a search pattern correspond to a position and a shape of the feature portion in the evaluation image among the plurality of search patterns and sets information indicating a search position corresponding to the specified search pattern as a comparison result, and
the process
detects an optical axis deviation amount corresponding to the search position indicated by the comparison result as the optical axis deviation amount of the imaging device.

3. The deviation amount detection device according to claim 1, wherein
the process
calculates the search pattern on a basis of information indicating a three-dimensional position of the feature portion based on a position of the imaging device in a case where it is assumed that there is no optical axis deviation of the imaging device and the optical axis deviation amount corresponding to each of the search positions.

4. The deviation amount detection device according to claim 3, wherein
the process
calculates the search pattern by multiplying a coordinate value indicating a three-dimensional position of the feature portion based on the position of the imaging device in a case where it is assumed that there is no optical axis deviation of the imaging device by a rotation matrix obtained on a basis of the optical axis deviation amount corresponding to each of the search positions and projecting a coordinate value obtained by the multiplication on the evaluation image.

5. The deviation amount detection device according to claim 4, wherein
the process
acquires a contour of a feature portion on the evaluation image corresponding to the optical axis deviation amount corresponding to each of the search positions,
by projecting the coordinate value obtained by the multiplication on the evaluation image; and
sets, as the search pattern, information in which a coordinate value indicating a centroid position of the acquired contour is associated with a coordinate value group indicating a relative distance from the centroid position of the contour to each of points constituting the contour.

6. The deviation amount detection device according to claim 1, wherein
the process
calculates, as a positional deviation amount, a difference between a centroid position of a contour of the feature portion in a case where it is assumed that there is no optical axis deviation of the imaging device in the evaluation image and a centroid position of a contour of the feature portion in the evaluation image in a case where it is assumed that the feature portion is arranged at each of the search positions, and
calculates the optical axis deviation amount corresponding to each of the search positions on a basis of the calculated positional deviation amount.

7. The deviation amount detection device according to claim 1, wherein
the process
sets a plurality of search positions in such a manner that the centroid position of the contour of the feature portion on the evaluation image when the optical axis deviation amount of the imaging device is maximum in an assumed range of the optical axis deviation amount of the imaging device is included in at least the search position.

8.-11. (canceled)

12. The deviation amount detection device according to claim 1, wherein
the feature portion is a window frame, an assist grip, a headrest, a B-pillar, a door frame, a shoulder anchor, or a sun visor of the vehicle.

13. The deviation amount detection device according to claim 1, wherein
the feature portion is a part of a window frame of the vehicle, and
the part of the window frame includes only an upper side portion of the window frame, or an upper side portion of the window frame and a side portion of the window frame in contact with the upper side portion of the window frame.

14. The deviation amount detection device according to claim 1, wherein
the imaging device is installed on a center console, a steering wheel column, an A-pillar, a rearview mirror, a dashboard, an instrument panel, or a ceiling.

15. A driver monitoring system comprising a sensor to monitor a state of an occupant of a vehicle using an optical axis deviation amount calculated by the deviation amount detection device according to claim 1 and an image of an inside of the vehicle captured by an imaging device.

16. A deviation amount detection method by a deviation amount detection device, the method comprising:
acquiring an image including a feature portion in a vehicle captured by an imaging device as an evaluation image;
setting a plurality of search positions distributed in a predetermined range from a position of the feature portion in a case where it is assumed that there is no optical axis deviation of the imaging device in the evaluation image;
calculating a search pattern indicating a shape of the feature portion in the evaluation image in a case where it is assumed that the feature portion is arranged at each of the search positions, the search pattern being based on an optical axis deviation amount corresponding to each of the search positions;
comparing the feature portion in the evaluation image with each of the plurality of search patterns for each of the search positions; and
detecting an optical axis deviation amount of the imaging device on a basis of a comparison result.

17. (canceled)
